(19) United States
(12) Patent Application Publication
(10) Pub. No.: US 2008/0011554 A1
(43) Pub. Date: Jan. 17, 2008

(54) Movable sensor device on the loading means of a forklift

(76) Inventors: Ralf Broesel, Berlin (DE); Sven Horstmann, Berlin (DE); Andreas Stopp, Neuenhagen (DE)

Correspondence Address: STEPHAN A. PENDORF, P.A., PENDORF & CUTLIFF, 5111 MEMORIAL HIGHWAY, TAMPA, FL, 33634, US

(21) Appl. No.: 10/555,365

(22) PCT Filed: May 4, 2004
(86) PCT No.: PCT/EP04/04715

§ 371 Date: Nov. 22, 2006

(30) Foreign Application Priority Data
May 26, 2003 (DE) 103 23 641.4

(51) Int. Cl. B66F 9/20

(52) U.S. Cl. 187/224

(57) ABSTRACT

Disclosed is a movable load sensor (1) for identifying and monitoring a load on a forklift (7). Said load sensor (1) detects the load, the lifting fork (2), and the environment located in front of the forklift (7). The detected sensor data is then evaluated by means of a computing unit (4). The inventive load sensor (1) is mounted so as to be movable relative to the mast (5) of the forklift (7) in synchrony with the load carrying means (6) while also being movable relative to the load carrying means (6) such that dynamic changes in the surroundings of the forklift (7) can be taken into consideration during the docking process, even in difficult lighting conditions.

### CROSS REFERENCE TO RELATED APPLICATION

This application is a national stage of PCT/EP2004/004715 filed May 4, 2004 and based upon DE 103 23 641.4 filed May 26, 2003 under the International Convention.

### BACKGROUND OF THE INVENTION

1. Field of the Invention

The invention relates to a method for the operation of a movable load sensor for the recognition and monitoring of a load on a forklift, as well as a movable load sensor on a forklift.

2. Related Art of the Invention

In the industrial sector there is a noticeable increased usage of driver-less transport systems. However, commercially available driver-less transport systems today are comparatively inflexible. They only move on a predetermined route and are unable to autonomously find their route. Likewise for stationary industrial robots the work environment must be adjusted to the robots. Hence these robots cannot be used for tasks in a dynamically changing work environment or in those cases where the placement of the load cannot be pre-determined. In the future autonomous, self-navigating all-purpose robots will work beyond the boundaries of pre-determined positions or routes. They will be working side by side with human workers in a dynamically changing environment. Modern mobile robots will need additional sensors to be able to fulfill the necessary and demanding requirements of such use. Commercially available distance-, imaging- or ultrasonic-sensors enable the determination of the exact location and load position of a vehicle as well as obstacle recognition for collision avoidance.

EP 0800129 B1 discloses an industrial truck, in particular a counter-weight forklift, which can be operated in either manual or automatic mode. For automatic operation the forklift utilizes a control system which manages the traction drive, the steering, the brake system and the motion controls of the lifting fork. Additionally arrangements have been made for a means to input and store potential routings and the transport task. Additional means are provided for the control of the truck's motion in dependence upon its position in space and the pred-etermined transport task. An odometric system as well as an image processing system with at least one navigation-camera, which in this case is mounted in the upper area of the driver's protection-roof on the side opposing the lifting fork, is used to autonomously determine the truck's position in space. At the least one additional camera is used to recognize physical presence, alignment and position of the palette. The attachment of this camera on the industrial truck ensures a constant position of the camera relative to the moving lifting fork. Lifting fork and/or truck motion are controlled depending on the position and alignment of the palette as well as the transport task. An additional means is provided to stop the truck in case there is an obstacle in its path.

Patent application WO 94/05586 shows an apparatus and a method to control a container crane. At least one sensor is utilized to determine the position of points on a ridge of the cargo gear or a container within the gear as well as one point on a ridge in the target location. This data is then used to control the cranes motion. The 2D-sensors in this application utilize a laser- or microwave-beam. An area-scan is generated by tilting the 2D sensor. For that reason the sensor is mounted movable relative to the direction of the measured ridges. Such a 3D-sensor delivers all three coordinates to determine a point in space.

In U.S. Pat. No. 4,279,328 an apparatus for the alignment of lifting gear, in particular of the load carrying means of a forklift is shown. The forklift in this case can either be an automatic or a semi-automatic forklift. The apparatus aligns the load carrying means in a particular position relative to the load. The apparatus comprises of a camera which generates images of the load. By means of a homogeneous light source, which is mechanically connected with the camera, a well defined image composed of shadows and reflections is opto-electronically detected. Camera and light source are attached to the load carrying means to ensure simultaneous motion. In this case a one-dimensional camera arrangement suffices, since the second dimension is delivered by the movement of the load carrying means during the scan. In order to keep the camera-s field of view clear from the load carrying means it is located below the load carrying means. When the load carrying means is lowered to the floor, the camera is protected by a mechanical stop which pushes the camera by means of a telescopic device above the level of the load carrying means, thus preventing mechanical damage. Lifting the camera above the level of the load carrying means however results in at least a partial obstruction of the camera's field of view, especially preventing an un-obstructed view onto the lifting fork or the load will not be possible. To make things worse the light sources, which move with the camera, will partly be covered by elements of the load carrying means, resulting in a non-homogeneous illumination. For these reasons it is necessary to steer the load carrying means blindly without actual visual information only relying on historical data while the load carrying means is set down or while the lifting fork is moving into the pockets of a euro-palette (docking). Clearly the disadvantage of a controls mechanism which is relying on historical data is its inability to react to dynamic changes of the environment and the relatively inaccurate positioning of the load carrying means.

### SUMMARY OF THE INVENTION

The object of this invention is to create a movable load-sensor on the load carrying means of a forklift and a method for the operation of said load-sensor, allowing highly accurate positioning of the load carrying means of a forklift by taking dynamic environmental changes into account.

According to the invention a movable load-sensor for the purpose of load-recognition and load-monitoring is utilized on a forklift. The attachment and alignment of said load sensor on the forklift is such that it can observe the load and/or the lifting fork and/or the environment ahead of the: forklift. The data acquired by the load-sensor is then analyzed by a computing unit. The attachment of the load-sensor is such that it moves simultaneously with the load carrying means and it is movable with respect to the mast of the forklift. In addition the sensor is movable relative to the load carrying means. For the case components of the forklift intrude into the field of view this feature allows moving the load-sensor in an advantageous manner relative to the load carrying means within pre-determined boundaries into a position with un-obstructed view. Another advantage of this arrangement resulting from its ability to move the load-sensor relative to the load carrying means is the possibility to check the position and alignment of the load during transport. To accomplish the movement of the load-sensor e.g. a linear drive on the load carrying means could be utilized. For the first time this invention allows the utilization of actual data of the dynamic changes in the forklift's environment during the docking. In contrast to automatically placed loads, a load for instance which has been moved by a worker will rot always be positioned in the exact same position. There are also cases where during docking the load is unintentionally moved out of position by the load carrying means of the forklift. The movable load-sensor allows under all circumstances, even under sub-optimal lighting conditions in an industrial environment, a precise detection of the loads position and alignment and the subsequent precise positioning of the load carrying means to adjust for the dynamic changes in the environment.

While driving without a load the load carrying means of a forklift usually is in the up position. It is advantageous to vertically move the load-sensor into a position under the lifting fork. Thereby the load sensor can map the environment ahead of the forklift. The acquired information can then be used e.g. for route planning or for obstacle recognition to avoid collisions. While carrying a load the load carrying means of a forklift is in an elevated position as well. It is advantageous to vertically move the load-sensor then above the level of the lifting fork. Thereby the position and alignment of the load can be observed and a potential shift of the load can be detected by the load sensor while the forklift drives. A load sensor which is positioned under the level of the lifting fork can detect the shift of the load as well. Here the shift of the load in respect to the lifting fork will be detected in an advantageous manner.

In another advantageous embodiment of the invention the load-sensor is horizontally movable into a position to the left or right of the lifting fork. While moving a load with the forklift the load sensor then observes the load and the environment alongside the load. The acquisition of the lateral distance between the load and the boundaries of its route e.g. will be more precise. Also for the usage in high rack storage areas a view alongside the lifting fork is of great advantage. Even without a load on the lifting fork the horizontal movement of the load sensor can be advantageous, e.g. to scan a load prior docking from a more suitable angle. Especially the additional ability to tilt the load sensor vertically and/or horizontally has proven to be very advantageous, since it allows the utilization of different views.

For the load recognition and monitoring distance detecting sensors are most suitable. A number of variations of these sensors are known to the expert. In particular commercially available laser scanners have proven to be a good choice as a load sensor. Laser scanners acquire 2D-data of the distance with a depth resolution of about 1 cm at a radius of 8 m and a visual angle of at least 180 degrees. It is certainly possible to arrange a number of these sensors on the load carrying means to be able to cover a larger area around the forklift. The utilization of visual information is also conceivable for load detection and monitoring. In this case imaging sensors like cameras with CCD arrays may be used. Various types of cameras are known to the expert, with sensitivity in the visible as well as the non visible range of the light spectrum. For the use as a load sensor on the moving load carrying means of a forklift a single line camera is sufficient. 2D distance data is generated by the movement of the load carrying means. It is also conceivable to arrange a number of sensors on the load carrying means. Particularly by means of a stereo arrangement depth information can then be generated. Utilization of acoustic information for the load recognition and monitoring is another conceivable embodiment. In an industrial environment predominantly ultra sonic sensors would be used. In comparison to opto-electronic sensors ultra sonic sensors feature a slightly lower resolution but are more cost efficient. In the context of the load sensor it is of course conceivable to combine a variety of different sensors as a movable load sensor and if necessary merge the various sensor data. Additionally the environmental data acquired by different sensors can be reconciled with the data from the odometric system of the forklift.

### BRIEF DESCRIPTION OF THE DRAWINGS

Additional attributes and advantages of the invention result from the following description of different embodiments by means of the illustrations.

FIG. 1 Forklift with a movable load sensor

FIG. 2a Detail view of the movable load sensor with positioning below the level of the lifting fork

FIG. 2b Detail view of the movable load sensor with positioning above the level of the lifting fork

FIG. 3 Approach of the forklift to pick up the load

FIG. 4 Lowering the load carrying means during docking

FIG. 5 Transport of a load with route monitoring

FIG. 6 Transport of a load with load monitoring

### DETAILED DESCRIPTION OF THE INVENTION

FIG. 1 shows an exemplary arrangement of the movable load sensor 1 on a forklift 7. The load sensor 1 is physically connected to and simultaneously movable together with the load carrying means 6 with respect to the mast 5. The load sensor 1 is additionally movable with respect to the lifting fork 2 within a pre-determined range. The environmental data acquired by the load sensor 1 is then evaluated by a computing unit 4. The computing unit 4 may also be used as the controls system of the forklift and its other sensors.

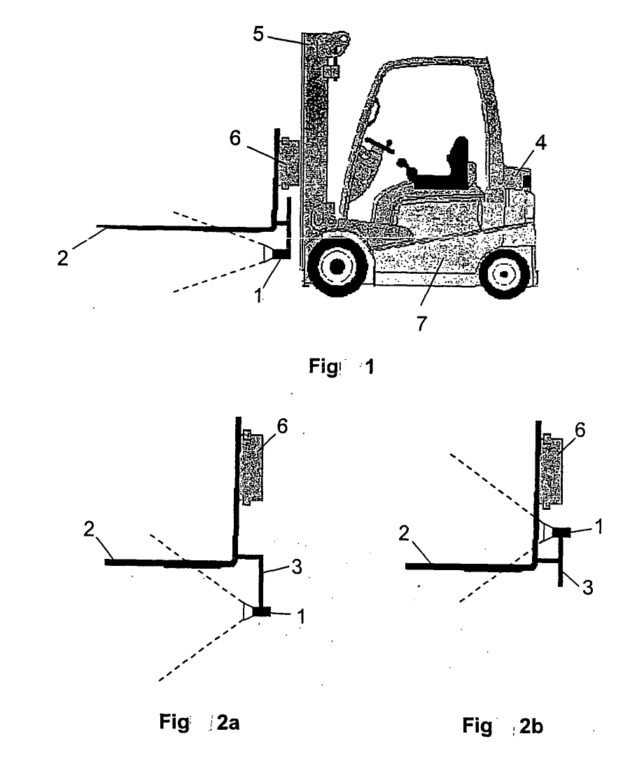

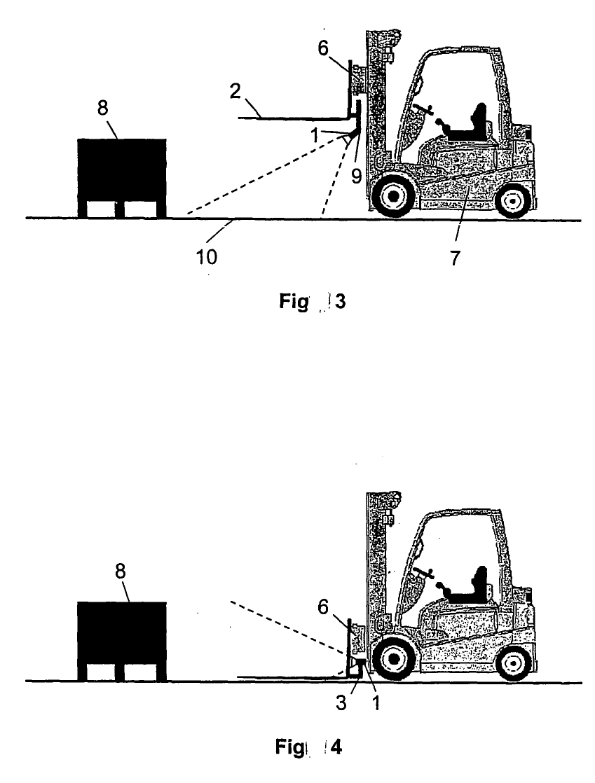

FIG. 2a shows an exemplary detailed view of the load sensor 1 which is physically connected to and simultaneously movable together with the load carrying means 6. Here the load sensor 1 is by means of a linear drive 3 additionally movable with respect to the lifting fork 2 within a pre-determined range. In the exemplary embodiment according to FIG. 2a the load sensor 1 is positioned below the level of the lifting fork 2. This variant is in particular of advantage with the load carrying means 6 of the forklift in an elevated position. Whereas in FIG. 2b a detailed view of the load sensor 1 is shown, in which said load sensor 1 is positioned above the level of the lifting fork 2. Here the mechanical components of the linear drive 3 are also located above the level of the lifting fork 2. Thereby it is possible to completely lower the lifting fork 2 down to the floor, without damaging the linear drive 3 or the load sensor 1.

In FIG. 3 a forklift 7 is shown with an apparatus according to the invention. The fork lift 7 is approaching the load 8 for a pickup. The load carrying means 6 prior to docking is still in an elevated position. Hence the load sensor 1 is preferably positioned below the level of the lifting fork 2. Arrangements are made for a pivoting mechanism 9 for horizontal and vertical tilt of the load sensor 1 to allow for different views. The alignment of the load sensor 1 is such that it can observe the route 10 as well as the load 8.

The forklift 7 in FIG. 4 is shown with the load carrying means 6 lowered to pickup a load 8. Here the Load sensor 1 is elevated above the level of the lifting fork 2 by means of the linear drive 3. Thus the load sensor 1 is even under difficult lighting conditions able to precisely observe the lifting fork 2 and load 8 during docking, while driving the lifting fork 2 into the pockets of a euro-palette 1, enabling positioning corrections if need be.

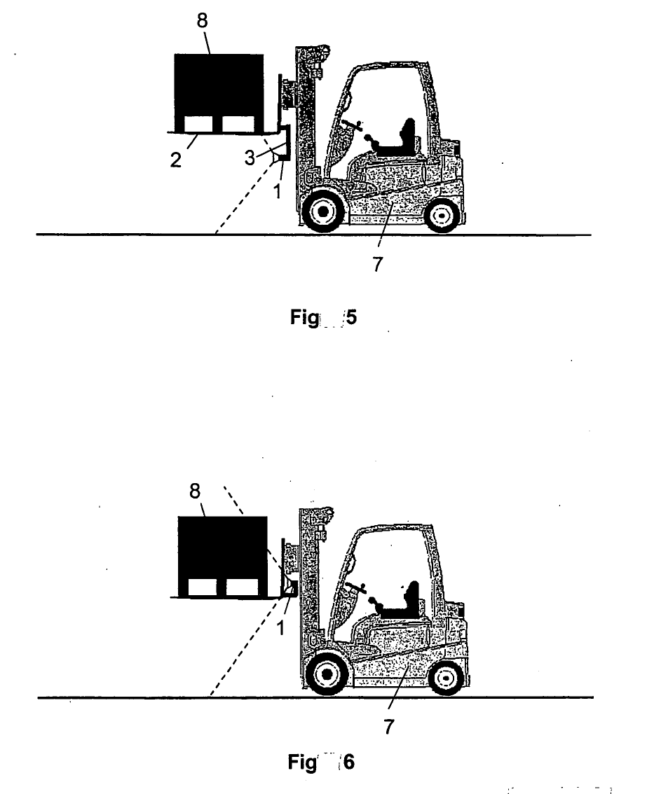

FIG. 5 shows the transport of a load 8 with the forklift 7. Here the load sensor 1 is positioned below the level of the lifting fork 2, such that the route of the fork lift can be observed, e.g. in the context of an obstacle recognition. In case the load sensor 1 is located only slightly below the level of the lifting fork 2 it can simultaneously detect a potential shift of the load 8 with respect to the lifting fork 2.

As shown in FIG. 6 it is also conceivable during the transport of a load 8 to position the load sensor 1 above the level of the lifting fork 2. In this case the load 8 as well as a part of the route and the lifting fork 2 can be observed during transport with the forklift 7. In an advantageous manner the load sensor 1 is also movable horizontally.

As a matter of course multiple/different sensors can be combined as the load sensor, such that the quality of the acquired environmental data is further improved, potentially resulting in new application scenarios. Furthermore additional pivoting mechanisms may be utilized in connection with the sensors.

1. A method for the operation of a movable load sensor (1) for load detection and load monitoring on a forklift, in which the load (3) and/or the lifting fork (2) and/or the environment ahead of the forklift (7) is observed by means of a load sensor (1), the sensor data acquired by the load sensor (1) is analyzed by a computing unit (4), and the load sensor (1) is movable simultaneously with the load carrying means with respect to the mast of the forklift, wherein the load sensor (1) is in addition movable with respect to the load carrying means (6) within a pre-determined range.

2. A method as in claim 1, wherein said load sensor (1) is vertically movable into a position above or below the level of the lifting fork (2).

3. A method according to claim 1, wherein the load sensor (1) is horizontally movable into a position to the left or right of the lifting fork (2).

4. A method according to claim 1, wherein the load sensor (1) can be tilted vertically and/or horizontally.

5. A method according to claim 1, wherein recognition and monitoring of the load is accomplished utilizing distance information.

6. A method according to claim 1, wherein recognition and monitoring of the load is accomplished utilizing visual information.

7. A method according to claim 1, wherein recognition and monitoring of the load is accomplished utilizing acoustic information.

8. A moveable load sensor (1) for load recognition and load monitoring on a forklift, in which said load sensor (1) is aligned such that it can observe the load (3) and/or the lifting fork (2) and/or the environment ahead of the forklift, and including a computing unit (4) to analyze the data acquired with the load sensor (1), in which said load sensor is supported such that it is movable simultaneously with the load carrying means with respect to the mast of the forklift, wherein a means is provided such that the load'sensor (1) is also movable with respect to the load carrying means (6) within a pre-determined range.

9. A moveable load sensor device according to claim 8, wherein a moving means is provided to vertically position the load sensor (1) above or below the lifting fork (2) level.

10. A moveable load sensor device according to claim 8, wherein a moving means is provided to horizontally position the load sensor (1) to the left or right or the lifting fork (2).

11. A moveable load sensor device according to claim 8, wherein the load sensor (1) can tilt in a vertical direction and/or swing in a horizontal direction.

12. A moveable load device according to claim 8, wherein the load sensor (1) includes at least one laser scanner.

13. A moveable load sensor device according to claim 8, wherein the load sensor (1) includes at least one image sensor.

14. A moveable load sensor device according to claim 8, wherein the load sensor (1) includes at least one ultrasonic sensor.
